(19) United States
(12) Patent Application Publication
(10) Pub. No.: US 2007/0129153 A1
(43) Pub. Date: Jun. 7, 2007

(54) Coupling for compensating axle misalignment

(75) Inventor: Markus Grebenstein, Munchen (DE)

Correspondence Address: WILLIAM COLLARD;COLLARD & ROE, P.C., 1077 NORTHERN BOULEVARD, ROSLYN, NY, 11576, US

(73) Assignee: Deutsches Zentrum Fur Luftund Raumfahrt e. V.

(21) Appl. No.: 11/384,885

(22) Filed: Mar. 20, 2006

(30) Foreign Application Priority Data
Dec. 7, 2005 (DE) 10 2005 058 661.9

(51) Int. Cl. F16D 3/00

(52) U.S. Cl. 464/98

(57) ABSTRACT

For compensating axle misalignment between an input shaft or output shaft and gearing a highly compact and lightweight shaft coupling is achieved, wherein a preferably monolithic mount comprises an outer ring (1), an inner ring (2) and at least two, preferably three, arcuate connecting webs (3a to 3d) configured between outer ring and inner ring.

### FIELD OF THE INVENTION

The invention relates to a coupling for compensating axle misalignment between input shaft or output shaft and gearing.

### PRIOR ART

Conventional, commercially available harmonic drive gearings feature an Oldham coupling as standard for compensating axle misalignment between input shaft and gearing. The disadvantages of an assembly comprising a harmonic drive gearing and Oldham coupling are its bulk and heavy weight; in addition, the harmonic drive gearing assembly plus Oldham coupling has high mass inertia.

To permit application of the harmonic drive gearing provided with an Oldham coupling as standard also in robotic attachments as well as lightweight robotic devices employed, for example, in minimal invasive surgery (MIS) the harmonic drive gearing on this type of robotic devices is without an Oldham coupling. However, due to the lack of compensating axle misalignment between input shaft and gearing such a joint results in substantial bias which greatly diminishes the feedback and transmission response of a robotic joint due to—among other things—an additional heavy ripple occurring.

### SUMMARY OF THE INVENTION

It is thus the object of the invention to develop a coupling for compensating axle misalignment which is compact and lightweight.

This object is achieved in accordance with the invention by a coupling wherein a preferably monolithic mount comprises an outer ring, an inner ring and at least two, preferably three, arcuate connecting webs configured between outer ring and inner ring. It is due to the arcuate or curved connecting webs between outer ring and inner ring serving as transmission struts and their design that in accordance with the invention an elastic compensating coupling is now achieved with a stiffness which is quasi-isotropic, i.e. independent of the direction of rotation and angular position for highly compact compensation of axle misalignment.

Depending on the embodiment of a drive and/or a gearing assigned thereto in each case, the coupling in accordance with the invention can be modified so that outer ring and/or inner ring comprise points of force application.

When, for example, as in the case of lightweight robotic attachments, a harmonic drive gearing is employed, the coupling in accordance with the invention is modified to the extent that points of force application are provided on the inner ring. The invention achieves an elastic shaft compensating coupling requiring no additional space. Furthermore, only low radial forces occur simultaneously with high torsional stiffness. In addition, the elastic compensating coupling in accordance with the invention features merely a low axial expansion whilst combining low moment of inertia with low weight.

The compensating coupling in accordance with the invention as well as its modifications can be put to use in drive systems, robotics, for example with lightweight robotic attachments, machine tools and in automotive engineering.

### DESCRIPTION OF THE DRAWINGS

The invention will now be described with reference to the drawings in which:

FIG. 1 is a plan view of a basic embodiment of a compensating coupling;

FIG. 2 is a plan view of a modified embodiment of a compensating coupling, and

FIG. 3 is a plan view of a modified embodiment as shown in FIG. 2 in combination with a harmonic drive gearing.

### DETAILED DESCRIPTION OF THE INVENTION

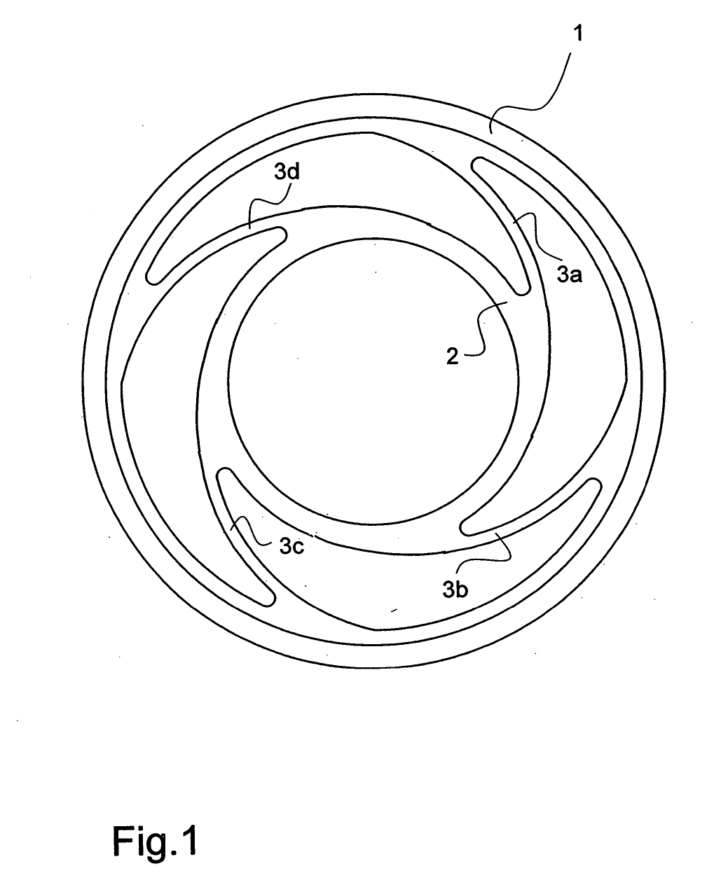

Referring now to FIG. 1 there is illustrated a basic embodiment of a compensating coupling comprising a preferably monolithic mount, an outer ring 1 and an inner ring 2 interconnected by arcuate or curved webs 3a to 3d.

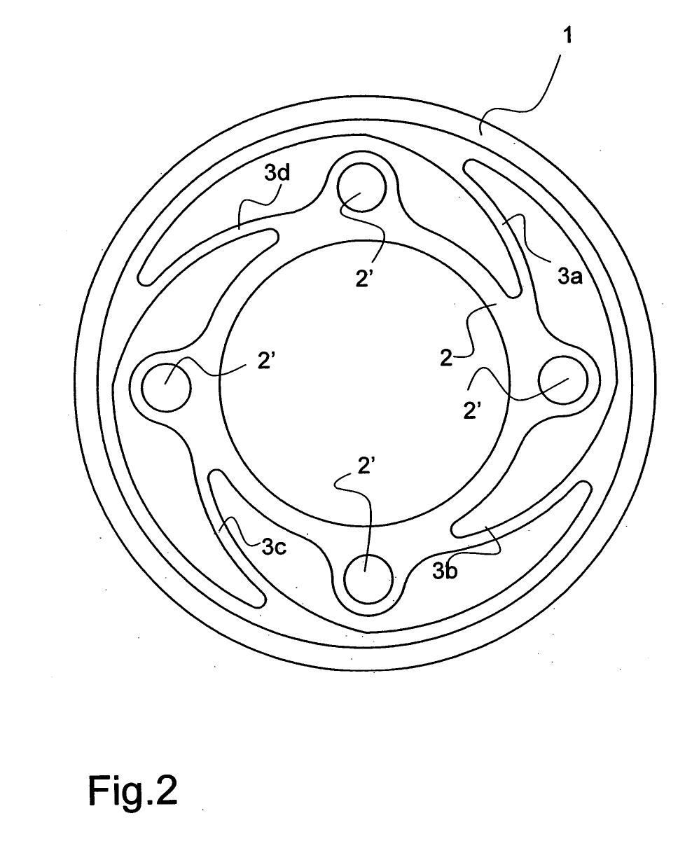

Referring now to FIG. 2 there is illustrated a modified embodiment of a compensating coupling which differs from the basic embodiment by points of force application 2′ being configured on the inner ring 2.

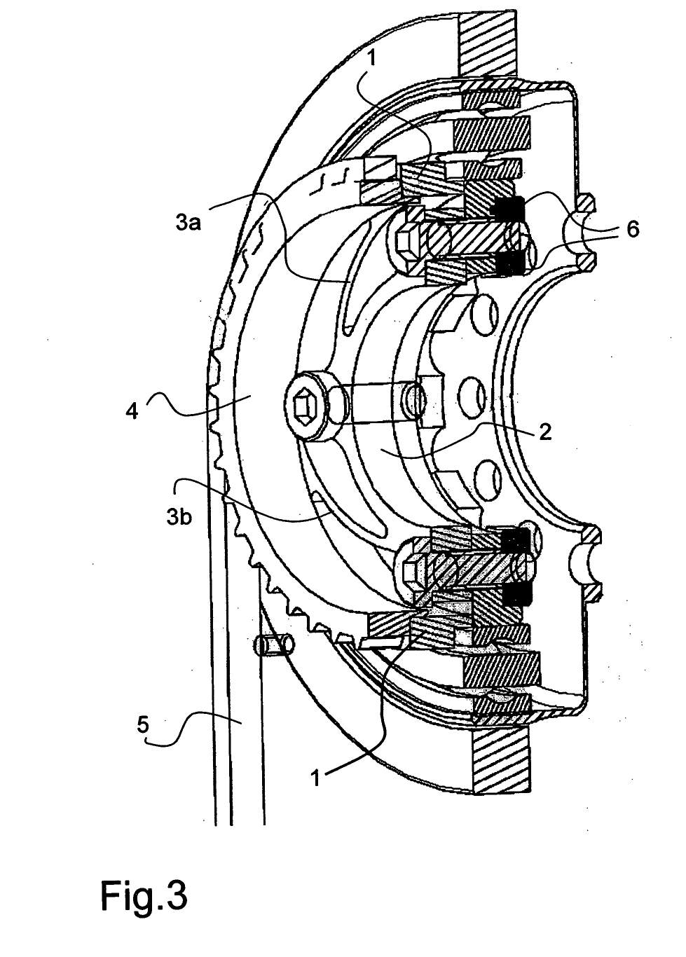

Referring now to FIG. 3 there is illustrated how the outer ring 1 of the compensating coupling is connected to a sheave 4 of a drive of which only part of a transmission ribbed belt 5 is indicated in FIG. 3. In FIG. 3 the inner ring 2 is connected for example to the wave generator 6 of a harmonic drive gearing.

It is because of the arcuate shape of the webs 3a to 3d that they are shortened or lengthened without being extended completely on application of a torque. The webs 3a to 3d are thus, because of the arcuate shape, subjected to substantially a flexural stress and not a tensile or compressive stress. This in turn results in the rigidity of the coupling being roughly the same in both directions as is of essential significance for power train control.

It can now furthermore be achieved in conjunction with a corresponding design of the radii of curvature of the webs, as may also be configured in other curved designs, and the web width that the radial forces resulting from the radial misalignment of the outer ring 1 to the inner ring 2 and the flexing of the four webs 3a to 3d of the embodiment as shown in FIG. 3 and thus also the disturbance moments in the gearing resulting therefrom are now practically independent of the angular position of the coupling since in no position do tensile or compressive stresses occur in the webs as would be the case, for example, with straight webs.

Due to the relatively long length of the arcuate webs 3a to 3d the radial forces resulting from the axle misalignment are very small. Accordingly, the elastic shaft coupling in accordance with the invention features a low stiffness to radial forces (bias minimization) whilst simultaneously exhibiting high torsional rigidity in thus achieving a considerable improvement in the control and vibration response.

Designing the rigidity of the elastic shaft coupling is achievable by correspondingly dimensioning the width, height as well as radii or curvature of the webs and by the corresponding choice of material; thus, for instance, aluminium can be replaced by plastics.

The compact elastic shaft compensating coupling in accordance with the invention can be put to use, for example, in drive systems, robotics, in machine tools and system engineering as well as in automotive engineering.

1. A coupling for compensating axle misalignment between input shaft or output shaft and gearing, wherein a preferably monolithic mount is provided comprising an outer ring (1), an inner ring (2) and at least two, preferably three, arcuate connecting webs (3a to 3d) configured between outer ring (1) and inner ring (2).

2. The coupling as set forth in claim 1, wherein points of force application (2′) are configured on the inner ring (2) and/or on the outer ring (1).

3. Use of the coupling as set forth in claim 1 for use in drive systems.

4. Use of the coupling as set forth in claim 2 for use in drive systems.

5. Use of the coupling as set forth in claim 1 for use in robotics particularly in lightweight robotic attachments.

6. Use of the coupling as set forth in claim 2 for use in robotics particularly in lightweight robotic attachments.

7. Use of the coupling as set forth in claim 1 for use in machine tools.

8. Use of the coupling as set forth in claim 2 for use in machine tools.

9. Use of the coupling as set forth in claim 1 for use in automotive engineering.

10. Use of the coupling as set forth in claim 2 for use in automotive engineering.
